(19) United States
(12) Patent Application Publication
(10) Pub. No.: US 2003/0234071 A1
(43) Pub. Date: Dec. 25, 2003

(54) Solid surface wall panel composite and method for making same

(76) Inventor: Mark Wayne Domanico, Naperville, IL (US)

Correspondence Address: FACTOR & PARTNERS, LLC, 1327 W. WASHINGTON BLVD., SUITE 5G/H, CHICAGO, IL, 60607, US

(21) Appl. No.: 10/178,076

(22) Filed: Jun. 21, 2002

(51) Int. Cl. B05D 5/10

(52) U.S. Cl. 156/71; 427/207.1

(57) ABSTRACT

The present invention relates to a panel composite sheet, comprising a sheet of solid surface material having a top surface and a bottom surface, a core sheet of material having a top surface and a bottom surface, wherein the top surface of the sheet of solid surface material is bonded to the bottom surface of the core sheet of material. The present invention further comprises bonding the top surface of the sheet of solid surface material with the bottom surface of the core sheet. The present invention also relates to a method for forming a panel composite sheet.

### BACKGROUND OF THE INVENTION

1. Field of the Invention

The present invention relates in general to a method of fabricating a composite panel, and, more particularly, to a method of fabricating a composite panel that includes solid surface material bonded to opposed surfaces of a thermo-set material for easy installation in the walls of bathtubs and/or shower stalls.

2. Background Art

Wall panel replacement or remodeling has long been known in the art. Due to the cost in panel replacement, alternative wall panels have been developed. Such alternatives include wall panels of solid surface material. Solid surface material possesses numerous properties that make it especially suitable for use in wall panels, including water resistance, fire resistance, scratch resistance, long-term wearability, cleanability, and low maintenance. While wall panels of solid surface material have provided an attractive alternative to wall panel replacement and remodeling, there are nevertheless drawbacks. Notwithstanding their advantageous properties, the solid surface panels, such as wall panels, are formed by a single sheet of material having a thickness, for example, of ¾-inch that is permanently bonded together (laminated) with, for example, a ½-inch solid surface sheet. Such wall panels can be quite heavy, which, in turn, renders them difficult to handle and mount. They are also susceptible to cracking on impact. In addition, several processing steps are required to manufacture such wall panels because solid surface panels are generally formed by sandwiching two sheets of material with an adhesive. Thus, the manufacture of solid surface panels is time-consuming, not to mention costly.

To address the above-discussed deficiencies of the prior art, it is a primary object of this invention to provide a cost-efficient method of fabricating a solid surface composite that requires less processing steps. It is another object of this invention to provide a method of fabricating a solid surface composite that is of decreased thickness and weight as well as increased flexibility.

These and other objects of the present invention will become apparent in view of the present specification, claims and drawings.

### SUMMARY OF THE INVENTION

The present invention relates to a panel composite sheet, comprising a sheet of solid surface material having a top surface and a bottom surface and a core sheet of material having a top surface and a bottom surface, wherein the top surface of the sheet of solid surface material is bonded to the bottom surface of the core sheet of material. The present invention further comprises a means for bonding the top surface of the solid surface sheet with the bottom surface of the core sheet, wherein the bonding means comprises a material integrally associated with the sheet of solid surface material.

The present invention also relates to a method for forming a panel composite sheet comprising the steps of 1) associating a liquid, solid surface material in a container, 2) mixing a hardening agent with the liquid solid surface material, 3) positioning a bottom surface of a core sheet of material into contact with at least a portion of the liquid solid surface material and hardening agent mixture; 4) hardening the solid surface material; and 5) bonding the bottom surface of the core of material to the top surface of the solid surface material.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other strictures for carrying out the same purposes of the present invention. Those skilled in the art should also realize that such equivalent constructions do not depart from the spirit and scope of the invention in its broadest form.

### BRIEF DESCRIPTION OF THE DRAWINGS

Reference is made to the accompanying drawings in which:

FIG. 1 illustrates an exemplary side-cross sectional view of a panel composite according to the principles of the present invention;

FIG. 2 illustrates an exemplary side-cross sectional view of a liquid, solid surface material that is placed in a container;

FIG. 3 illustrates an exemplary side-cross sectional view of the bottom surface of a core sheet of material positioned into contact with at least a portion of the mixture of liquid, solid surface material and hardening agent; and

FIGS. 4 and 5 schematically illustrate exemplary front and side views, respectively, of an exemplary panel composite according to the principles of the present invention used in association with a wall panel.

### BEST MODE FOR PRACTICING THE INVENTION

While this invention is susceptible of embodiment in many different forms, there is shown in the drawings and will be described in detail, one specific embodiment with the understanding that the present disclosure is to be considered as an exemplification of the principles of the invention and is not intended to limit the invention to the embodiment illustrated.

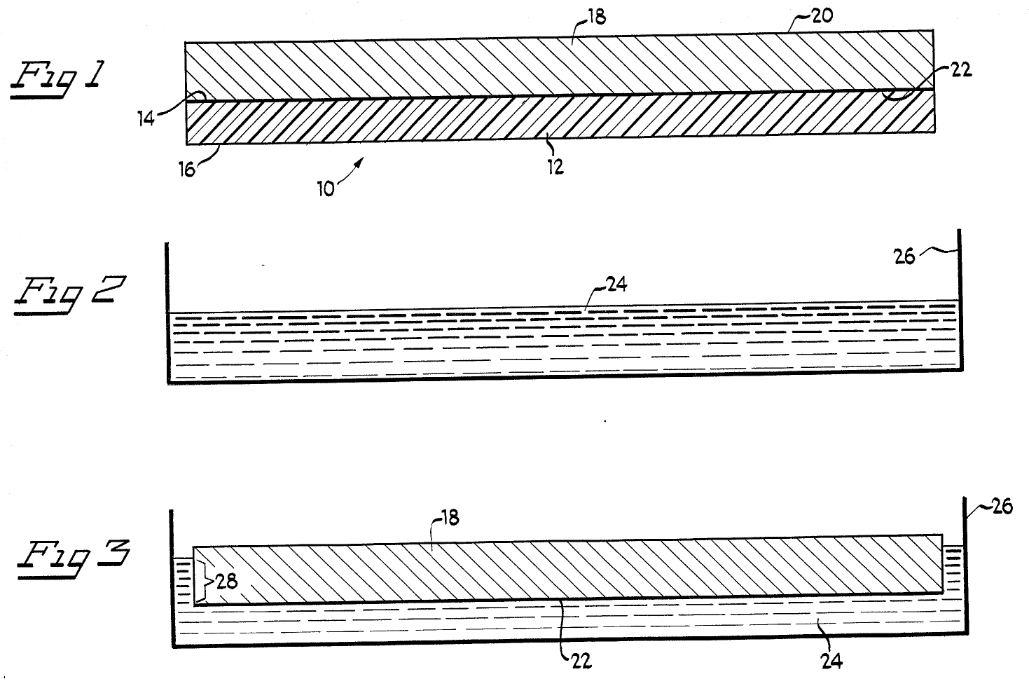

Referring initially to FIG. 1, a side-cross sectional view of a panel composite 10 according to the principles of the present invention is shown. Panel composite 10 includes sheet of solid surface material 12 having top surface 14 and bottom surface 16. Panel composite 10 further includes core sheet 18 having top surface 20 and a bottom surface 22. As illustrated in FIG. 1, top surface 14 of solid surface sheet 12 is bonded to bottom surface 22 of core sheet 18. Included in this embodiment is a means for bonding top surface 14 of solid surface sheet 12 with bottom surface 22 of core sheet 18, such that the bonding means comprises a material integrally associated with solid surface sheet 12. In a preferred embodiment, the material integrally associated with solid surface sheet 12 is a conventional hardening agent.

In one embodiment, solid surface material 12 is fabricated from any one of a polymer-based material, Corian, avanite and screl. Solid surface materials are conventionally available from various sources, for example, under the trademark CENTURA, available from Centura Solid Surface, Inc. and under the trademark CORIAN, available from DuPont. Those skilled in the art, however, understand that other solid surface materials may also be used to manufacture panel composite 10.

Solid surface materials provide numerous advantages that are especially beneficial in panel composites including high scratch resistance, long-term wearability, limited maintenance as well as water-resistance and fire-retardance. However, panel composites formed of solid surface material are also quite heavy because panel composites are known to comprise a ½-inch or more sheet of solid surface material that is adhered or laminated to a ¾-inch or more inexpensive sheet of material. Thus, conventional panel composites can be quite heavy and difficult to handle and mount. For this reason, the present invention provides a panel composite of decreased thickness and thus, decreased weight, which provides for a more flexible panel composite. Furthermore, the present invention advantageously provides for a method of fabricating a panel composite of solid surface material that is of decreased thickness and weight, as well as increased flexibility.

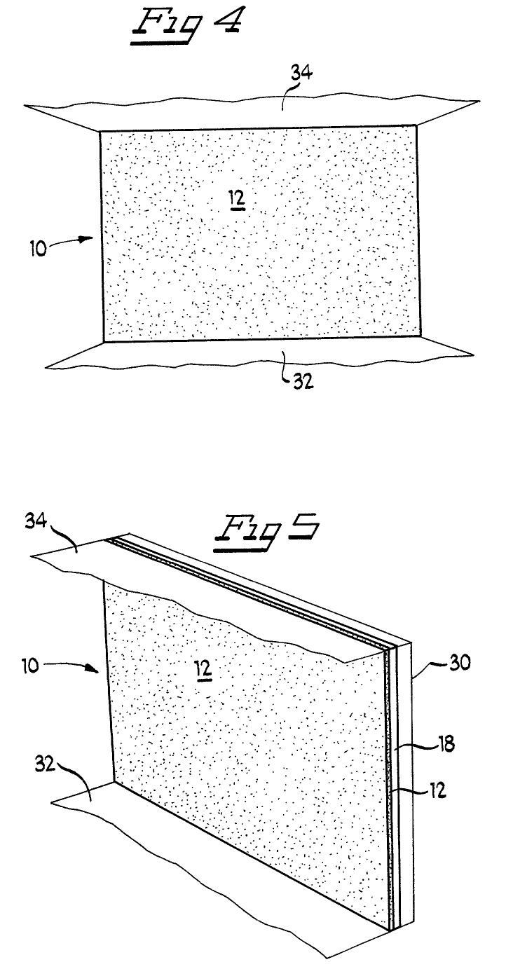

Turning now to FIGS. 2 and 3, illustrated is a method for fabricating panel composite 10 according to the principles of the present invention. Referring to FIG. 2, illustrated is a side cross sectional view of mixture 24 of liquid, solid surface material and hardening agent that have been poured into container 26. Container 26 may be a mold, a jig, or any container capable of housing mixture 24. Container 26 should be of an appropriate size to provide for the desired length and width of panel composite 10. In forming panel composite 10 of the present invention, it is advantageous to uniformly mix the hardening agent and the liquid, solid surface material.

As will be described hereinafter, it may be desirable to incorporate various additives and/or filler materials into mixture 24 of the liquid, solid surface material and hardening agent to enhance the properties of panel composite 10. It is further contemplated that the various additives and/or filler materials may be added into mixture 24 so long as such additives/and or filler materials do not effect the means of bonding core sheet 18 to the solid surface material. Examples of such additives and/or filler materials include a colorant to provide a desired color for panel composite 10. Also, an agent may be added to increase the flexibility or resiliency of panel composite 10 somewhat so as to better withstand impacts without cracking and enhance resiliency. Thus, the resulting solid surface sheet 12 may comprise a product that is 98 percent de-aired, utilizing a matrix consisting of resins (for example, polyester, acrylic or a combination thereof) and inert fillers, most commonly aluminum trihydrate (ATH), to render the solid surface sheet 12 fire-retardant.

It is further contemplated that, rather than mixing the additives and/or filler materials with the liquid, solid surface material/hardening agent mixture 24 in the container 26, the additives and/or filler materials may be mixed with the liquid, solid surface material prior to pouring the liquid, solid surface material into container 26. For example, the additives and/or filler materials may be mixed and homogenized in a vacuum mixer, forcing air from the product (so that the product is 98 percent or better de-aired). After a short mixing cycle, the solid surface material and additives and/or filler materials may then be transferred into container 26 where the hardening agent is then added.

Turning now to FIG. 3, illustrated is an exemplary side-cross-sectional view of bottom surface 22 of core sheet 18 positioned in contact with at least a portion of mixture 24 of the liquid, solid surface material and hardening agent. As illustrated in FIG. 3, a predetermined amount of mixture 24 may be poured into the container 26 such that only a portion 28 of the core sheet 18 is encapsulated by the mixture 24 after core sheet 18 is positioned into mixture 24. Thus, the amount of the mixture 24 of liquid, solid surface material/hardening agent that is poured into the container depends not only on the desired thickness of the panel composite 10, but also on the desired portion of the core sheet 18 that is to be encapsulated by the mixture 24. Alternatively, it is contemplated that the predetermined amount of mixture 24 may be poured into the container 26 such that mixture 24 may be able to encapsulate the entire core sheet 18 after the core sheet 18 is positioned into the mixture 24. In such embodiments, the solid surface sheet 12 will be on both sides of the core sheet 18 to form a panel composite 10 that may be used, for example, as a wall partition. The material of the core sheet 18 may be comprised of a lightweight material to which the liquid, solid surface material can be effectively bonded. The core sheet 18 may be fabricated from various, usually thermo set materials such as plastic, polyester, acrylic or DR over ABS. Various other materials may also be used to fabricate the core sheet 18 so long as the core sheet may effectively serve as a core for the mixture 24 of liquid, solid surface material/hardening agent. Examples of such materials used to fabricate the core sheet 18 include plywood, fiberglass or aluminum.

In a preferred embodiment, the bonding means comprises a mixture 24 of the hardening agent and the solid surface material in its liquid, ambient state being associated with the bottom surface 22 of the core sheet 18 prior to the hardening of the liquid, solid surface material. Specifically, the liquid, solid surface material hardens before the bottom surface 22 of the core sheet 18 bonds to the top surface 14 of the solid surface sheet 12. In a preferred embodiment, the bonding means comprises chemically altering the bottom surface 22 of the core sheet 18 by associating the bottom surface 22 of the core sheet 18 with the liquid, solid surface material/hardening agent mixture 24 so as to result in a chemical bond between the solid surface sheet 12 and the core sheet 18. By bonding the core sheet 18 together with the solid surface material over the entire bottom surface 22 of the core sheet, any chipping or cracking of the solid surface sheet 12 that occurs will not cause other portions of the solid surface sheet 12 to separate from the core sheet 18 and, thus, the integrity of the overall panel composite 10 will effectively be maintained.

The solid surface sheet 12, in a preferred embodiment, has a thickness from about 1/16 inch to about ⅛ inch thick. The core sheet 18 itself preferably has a thickness of about 1/10 inch to about ⅛ inch thick. Thus, the present invention advantageously provides for a panel composite 10 having a thickness from about 0.16 to about 0.25 inches It should be understood, however, that although the preferred thickness of the panel composite 10 provides several advantages, the preferred thickness is not intended to limit the panel composite 10 to any particular thickness. Such advantages associated with a thinner panel composite include a panel composite of lighter weight, and thus, a more flexible composite that is easier to handle and mount. In addition to being relatively thin and light in weight, it is also highly shatter-resistant because the core sheet 18 supports the solid surface sheet 12 and functions as a backing for the solid surface sheet 12. Accordingly, even if the solid surface sheet 12 is to crack or break due to impact, the core sheet 18 maintains the integrity of the overall panel composite 10.

After the liquid, solid surface material is allowed to bond to the core sheet 18, the panel composite 10 is demolded or removed from the container 26 and dimensioned to the existing wall by using an appropriate sander like, for example, a drum belt sander. The panel composite 10 may also be fed through a surface sander to fully dimension the system on the solid surface side of the panel composite 10. As mentioned above, those skilled in the art understand that a second solid surface sheet may be bonded to the core sheet 18 on the other side of the core sheet 18 to provide for a panel composite 10 that may be used, for example, as a wall partition. In such embodiments, the panel composite 10 may be more than ½ inch thick to utilize conventional mounting hardware components and associated installation products.

FIGS. 4 and 5 illustrate front and side views, respectively, of exemplary panel composites used in association with a wall panel according to the principles of the present invention. As illustrated in FIG. 5, the panel composite 10 is dimensioned as to length and width to define a wall 30 between the floor 32 and the ceiling 34. In other designs, the panel composite may be dimensioned to extend to cover only part of the wall 30. After the panel composite 10 is demolded or removed from the container 26 and dimensioned to the existing wall 30, the panel composite 10 may be adhered onto an existing wall 30 using conventional adhesives. If the solid surface sheet 12 should crack or chip, the panel composite 10 may usually be repaired. Superficial damage to the solid surface sheet can usually be repaired by sanding or polishing. For deeper surface damage, a liquid, solid surface liquid material that is formulated to match the solid surface sheet 12 may be used. The resultant product is highly chemical-resistant, stain resistant and repairable and can be tooled into many shapes and designs using conventional tools.

As is known to those skilled in the art, panel composites may be designed in numerous ways, and FIGS. 4 and 5 are only intended to be exemplary of uses. For example, the panel composite may be used as partition panels. In such embodiments, fixtures such as lamps may be mounted to interior walls of the panel composite 10 as desired. Alternatively, the panel composite 10 may be used as an alternative to desktop surfaces. In one embodiment, the panel composite 10 is used as a bathtub or shower stall liner in connection with a bathtub or shower stall. In such uses, the panel composite 10 is removed from the container 26 and dimensioned to an existing bathtub or shower stall to form a bathtub or shower stall liner. The panel composite is then adhered onto the existing bathtub or shower stall liner.

According to the principles of the present invention, a panel composite 10 is provided that has a relatively thin solid surface sheet 12 bonded to an opposed surface of a light-weight core sheet to provide a panel composite 10 with advantageous properties of a solid surface material and, at the same time, provides a relatively thin, light in weight and flexible panel composite. Furthermore, the present invention provides a relatively easy method of manufacturing the panel composite, which is less time consuming and, in turn, more cost efficient.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A panel composite sheet, comprising:
a sheet of solid surface material having a top surface and a bottom surface;
a core sheet of material having a top surface and a bottom surface, wherein the top surface of the sheet of solid surface material is bonded to the bottom surface of the core sheet of material; and
means for bonding the top surface of the sheet of solid surface material with the bottom surface of the core sheet, wherein the bonding means comprises a material integrally associated with the sheet of solid surface material.

2. The invention according to claim 1, wherein the bonding means comprises a mixture of the hardening agent and the solid surface material in its liquid, ambient state being associated with the bottom surface of the core sheet of material prior to the hardening of the liquid, solid surface material.

3. The invention of claim 3, wherein the solid surface sheet is selected from the group consisting of: a polymer-based material, Corian, avanite and screl.

4. The invention of claim 2, wherein the hardening agent comprises a conventional hardening resin.

5. The invention of claim 1, wherein the solid surface sheet has a thickness from about 1/16 inch to about ⅛ inch thick.

6. The invention of claim 1, wherein the core sheet of material has a thickness from about 1/10 inch to about ⅛ inch thick.

7. The invention of claim 9, wherein the panel composite has a thickness from about 0.16 to about 0.25 inches.

8. The invention of claim 1, wherein the panel composite comprises a bathtub or shower stall liner.

9. A method for forming a panel composite sheet comprising the steps of:
associating a liquid, solid surface material in a container;
mixing a hardening agent with the liquid, solid surface material;
positioning a bottom surface of a core sheet of material into contact with at least a portion of the liquid, solid surface material and hardening agent mixture;
hardening the solid surface material; and
bonding the bottom surface of the core sheet of material to the liquid, solid surface material.

10. The process according to claim 9, wherein the step of bonding comprises chemically altering the bottom surface of the core sheet of material by the liquid, solid surface material/hardening mixture so as to result in a chemical bond between the liquid, solid surface material and the core sheet of material.

11. The process of claim 9, wherein the step of associating includes the step of associating the liquid, solid surface material selected from the group consisting of a polymer-based material, Corian, avanite and screl.

12. The process of claim 9, wherein the step of mixing includes mixing a hardening agent of a conventional hardening resin.

13. The process of claim 9, wherein the steps of associating and mixing includes the steps of associating and mixing such that a resulting sheet of solid surface material has a thickness from about 1/16 inch to about ⅛ inch thick.

14. The process of claim 9, wherein the step of positioning includes positioning a core sheet having a thickness from about 1/10 inch to about ⅛ inch thick.

15. The process of claim 9, wherein the step of hardening includes the step of hardening such the panel composite has a thickness from about 0.16 to about 0.25 inches.

16. The process of claim 9 further comprising the steps of
removing the panel composite from the container and
dimensioning the panel composite to an existing wall after the step of bonding.

17. The process of claim 16 further comprising the step of adhering the panel composite onto an existing wall after the steps of removing and dimensioning.

18. The invention of claim 9 further comprising the steps of
removing the panel composite from the container and
dimensioning the panel composite to an existing bathtub or shower stall to form a bathtub or shower stall liner.

19. The invention of claim 18 further comprising the step of adhering the panel composite onto an existing bathtub or shower stall liner after the steps of removing and dimensioning.

20. A method for forming a panel composite sheet comprising the steps of:
associating a liquid, solid surface material in a container;
mixing a hardening agent with the liquid solid surface material;
positioning an entire core sheet of material into contact with the liquid, solid surface material and hardening agent mixture;
hardening the solid surface material; and
bonding a top surface and a bottom surface of the core of material with the liquid, solid surface material.
